(19) United States
(12) Patent Application Publication
(10) Pub. No.: US 2014/0028852 A1
(43) Pub. Date: Jan. 30, 2014

(54) CONTROL FOR VEHICLE IMAGING SYSTEM

(71) Applicant: MAGNA ELECTRONICS INC., Auburn Hills, MI (US)

(72) Inventor: Ghanshyam Rathi, Mississauga (CA)

(21) Appl. No.: 13/942,753

(22) Filed: Jul. 16, 2013

Related U.S. Application Data
(60) Provisional application No. 61/676,405, filed on Jul. 27, 2012.
(60) Provisional application No. 61/675,544, filed on Jul. 25, 2012.

(51) Int. Cl. H04N 7/18

(52) U.S. Cl. CPC H04N 7/181
USPC 348/159

(57) ABSTRACT

A vision system for a vehicle includes a plurality of cameras disposed at a vehicle equipped with the vision system. Each of the cameras has a respective field of view and is operable to capture respective image data. The vision system may include or utilize a video file format that makes available required or desired image data and other information in a synchronized way, and that enables access to the image data and information by algorithms. The video file format may create a layout that allows the system to store and access the data in a generalized manner. The system may include a video control interface software tool that defines a protocol for interfacing with external devices and subsequent processing software.

### CROSS REFERENCE TO RELATED APPLICATIONS

The present application is related to U.S. provisional application Ser. No. 61/676,405, filed Jul. 27, 2012, and Ser. No. 61/675,544, filed Jul. 25, 2012, which are hereby incorporated herein by reference in their entireties.

### FIELD OF THE INVENTION

The present invention relates to imaging systems or vision systems for vehicles and, more particularly, to a vision system that includes at least one imaging device or camera for capturing images exteriorly of the vehicle.

### BACKGROUND OF THE INVENTION

Use of imaging sensors in vehicle imaging systems is common and known.

Examples of such known systems are described in U.S. Pat. Nos. 5,949,331; 5,670,935; and/or 5,550,677, which are hereby incorporated herein by reference in their entireties.

### SUMMARY OF THE INVENTION

The present invention provides a vision system or imaging system for a vehicle that utilizes one or more cameras to capture images exterior of the vehicle, and provides an enhanced video file format that makes available the required or desired data in a synchronized way, enabling easy access to the data by the algorithms. The format creates a special layout that allows it to store and later find the data in a very generalized way. The present invention also provides a video control interface software tool that defines a protocol for interfacing with external devices (such as cameras) and subsequent processing software. The tool or system loads a run-time configurable driver (which conforms to the protocol) to interface a given device in question and makes the data available in the video format or VID format (such as a .vid file format) to run-time configurable plug-ins that can post process the captured data before storing it on a disk file with VID Format. The present invention also provides an application control software engine that loads a run-time configurable algorithmic plug-ins. The software engine or system can interface with the video control for live processing or to VID files for off-line processing. The software engine or system creates a framework and defines protocols such that complicated algorithmic modules can be built in a modular way. One module can process data from upstream module and pass on its output for further processing by the downstream modules. A library of such modules can be developed and re-used for different algorithmic applications.

These and other objects, advantages, purposes and features of the present invention will become apparent upon review of the following specification in conjunction with the drawings.

### BRIEF DESCRIPTION OF THE DRAWINGS

FIG. 1 depicts the file format along with the extensions;

FIG. 2 is a screen shot of a plurality of VID files in accordance with the present invention;

FIG. 3 is a sample dialog box;

FIG. 4 is an extract from the API to access the VID files;

FIG. 5 is a schematic of the structure of the video control (VIDCtrl) platform;

FIG. 6 is a printout of a VIDCtrl process of the present invention;

FIGS. 7-10 show an example of a driver interfacing with a sensor with the corresponding user interface for VIDCtrl displaying the information about the embedded frame data;

FIGS. 11 and 12 show an example of a driver interfacing with a sensor;

FIG. 13 is a printout of the VIDCtrl process of loading and initializing a plug-in;

FIG. 14 is a schematic showing the VIDCtrl interfaced with Simulink;

FIG. 15 is a schematic of the structure of the application control (APPCtrl) platform;

FIG. 16 shows an example of the APPCtrl configuration file;

FIG. 17 shows an APPCtrl API that is available to the plugins;

FIG. 18 shows an example of the data exposed by a VideoImage PlugIn; and

FIG. 19 shows an example of the data exposed by a CANTranslation PlugIn.

### DESCRIPTION OF THE PREFERRED EMBODIMENTS

### VID Format With Extension:

Since its inception, a VID file format has served the needs of the user and is actively being used for test video capture, research and development purposes. Apart from storing the image data, it allows for various facilities, such as, for example, having a timestamp included with every frame for providing a consistent timescale or attaching all the information from the image sensor on a per frame basis for ensuring the image quality or storing application related algorithmic information for the image processing performed along with the annotation data for debug/development purposes and the like. Various utilities are available such as VIDExplorer (viewing the video), VIDShExt (VID Shell Extension—for thumbnail representation of the VID file along with the viewing capabilities from windows explorer itself), MATLAB/SIMULINK interface, C++ interface to VID files and/or the like.

### File Format:

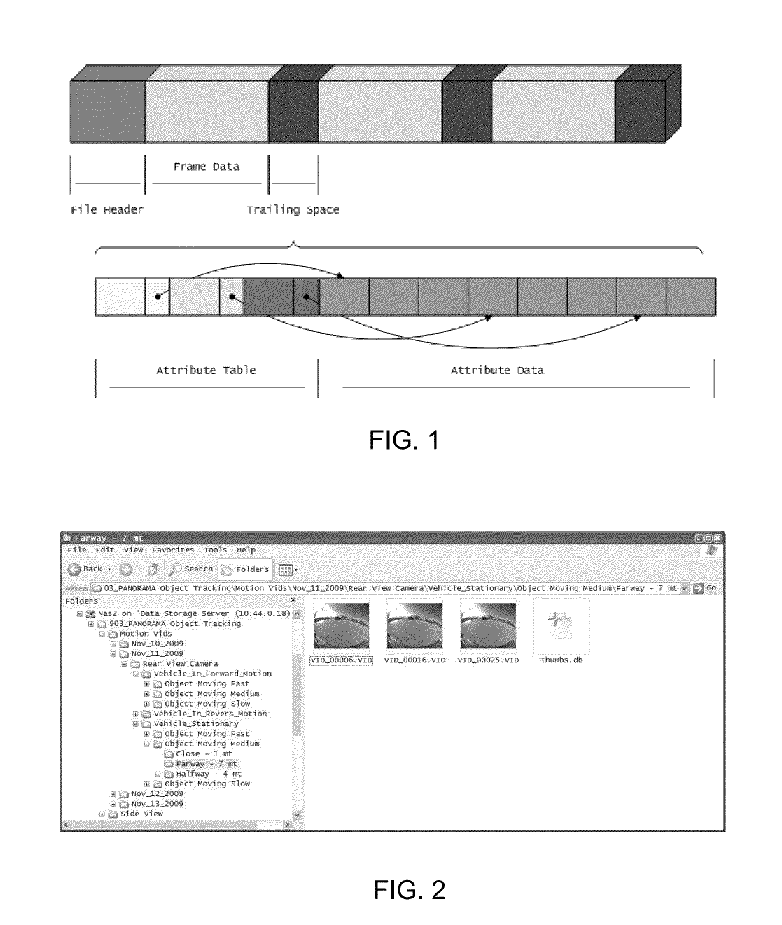

An understanding of the VID file format is necessary in order to follow the extensions described herein. FIG. 1 depicts the file format along with the extensions. As shown in FIG. 1, the VID file format consists of a file header at the start of the file that contains information about the video data, such as the width, height, video type, frame size and/or the like. It is then followed by the frame data with some trailing space at the end of each frame. This trailing space is the storage for the extensions. The applications that use the VID file actually read a complete frame data (which contains the image and the trailing space) and after extracting the relevant image, can utilize the metadata embedded in the trailing space.

This trailing space becomes a key to the extensions developed. The extension puts a structure into this space in order to store meta-data in a consistent format. All the data is stored as attributes (named values).

Format Extension (Metadata storage):

The structure essentially consists of a signature to identify the structured data as opposed to the plain trailing space (slack space). It is then followed by a table, listing all the attributes present. The table contains a pointer to the actual attribute data. The table also holds an indicator specifying whether particular attribute data is valid for any given frame (it is possible or likely that even though the space is reserved for an attribute, it may not have a valid data for some frames). Thus, any number and size of data can be stored as named attributes on a per frame basis. The C++ interface for the VID file provides a consistent and convenient API for manipulating the attribute data programmatically while the shell extension (VIDShExt) can show/copy to clipboard, the values of the attribute data in a user friendly way. This enables a way to store any information in the same existing VID file format with extension. Since applications can essentially ignore the irrelevant information, almost anything (image from a second sensor for stereo vision, heterogeneous sensor information such as from a radar sensor, or time of flight (TOF) data and/or the like, can be combined with the optical data, classification information—temporal model states and the like) can be seamlessly stored and re-played back to re-create exactly or substantially exactly the situation for any application development and/or testing.

The extension also provides a way to store any meta-data that pertains to the complete video clip (rather than each frame). For example, information such as the lighting condition of video capture, object information, classification information and/or the like can be stored in the VID file itself for later retrieval or analysis. The extension provides this facility while still maintaining full backward compatibility by taking advantage of the way data is stored by the NTFS file system on Windows. Data for each file is stored as named streams. The default stream is the file data itself, but nothing prevents an application from storing more than one stream for a given file (this is the same mechanism used by the Operating System to store the security/access information for any given file). By making this facility available conveniently through the API, almost any amount and any number of meta-data can be stored easily in the VID file itself. The standard applications access only the default stream and hence will essentially ignore these extra data streams while the format aware applications can take full advantage of this facility.

This essentially transforms the VID file into a small convenient database itself with full backward compatibility that can be used in variety of ways, yet, using a consistent interface.

### VID File Interface:

Convenient interfaces are available to access the VID files. One is for essentially ‘viewing’ the data through the ‘Windows Shell Extension’ and the other is manipulating the data programmatically through the API provided by ‘VIDFileEx.dll’.

### Shell Extension:

Windows shell extension integrates itself with Windows Explorer and provides a facility to view the data from the VID files. It allows the Windows Explorer to generate the thumbnail view of the VID Files, which is useful to quickly ‘know’ the contents of the video clip visually. To view the meta-data embedded within the VID files, a plurality of VID files can then be selected in Windows Explorer and the ‘properties’ context menu can be accessed and the properties dialog box can be invoked. The extension essentially adds a property page called ‘MV Video’ to show the contents of the VID file(s) selected (FIG. 2).

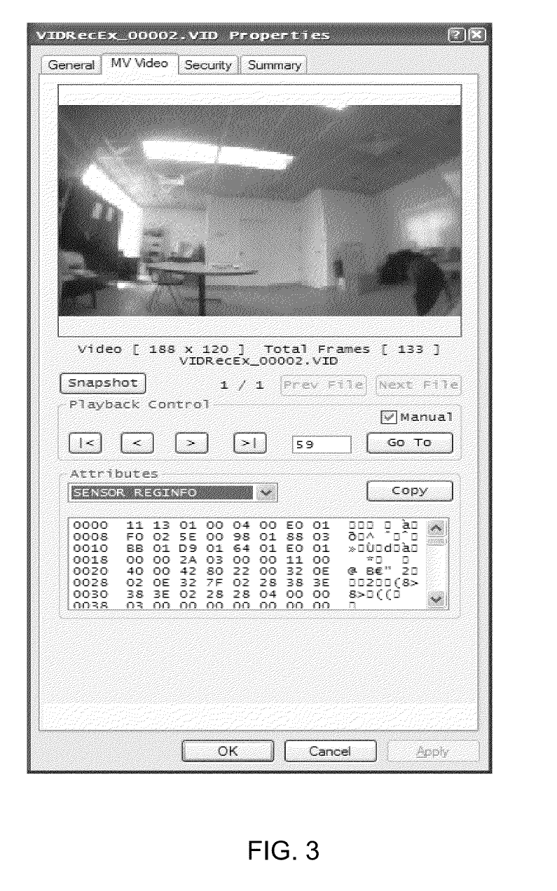

FIG. 3 shows a sample dialog box. As can be seen in FIG. 3, the actual video is played back to visually see the video clip with convenient controls for stepping through the video frame-by-frame or accessing any particular frame from the given video or jumping easily between the selected VID files etc. It also has an interface for viewing the stored ‘attributes’. Any attribute can be selected for viewing from the ‘Attributes’ drop down box. If needed, the attribute data can be copied to the clipboard for deeper analysis.

### C++ API:

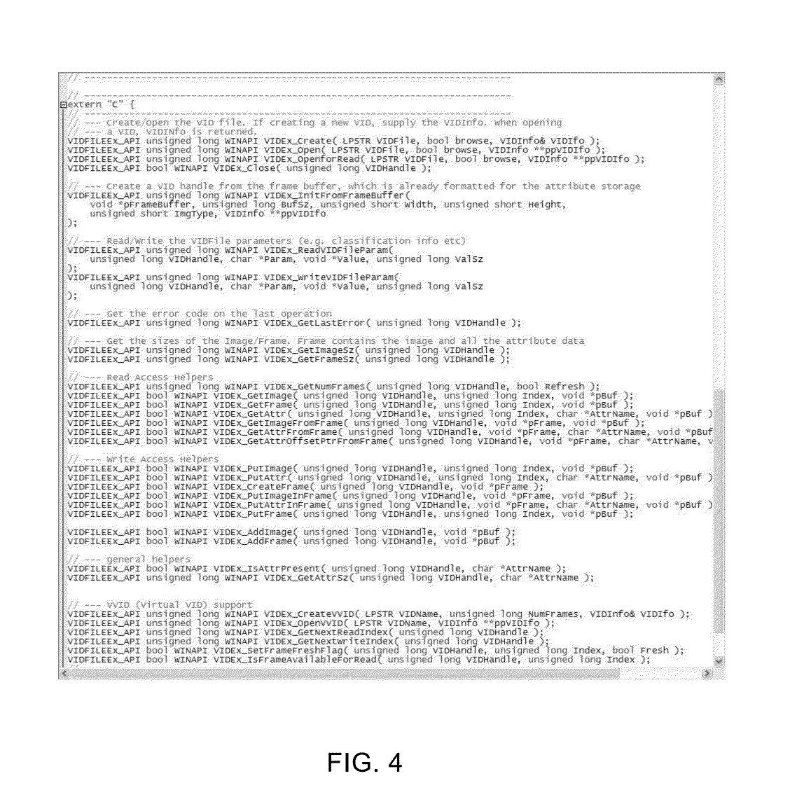

An extract from the API to access the VID files (VIDFileExt.h) is listed and shown in FIG. 4. As can be seen in FIG. 4, a quite comprehensive API makes it very easy to manipulate/generate the VID files. This API is fully free threaded and appropriate file locking is managed by the interface internally so that, the VID files can be manipulated with ease as much as, the VID file can be created by one process while another can modify the attribute data while the recording of the video is still in progress.

### MATLAB API:

VID files can be accessed from MATLAB using the matlab extensions “MExVIDEx.mex”. This interface allows opening any video file, accessing any frame randomly and accessing the attribute data that is embedded in the video. Thus, MATLAB can seamlessly use all the VID files recorded with full functionality offered by the format.

[Img, NumFrames]=MExVIDEx(VIDName, FrameIndex)

### VID Format File Layout:

The VID file format, as described above, consists of a file header at the start of the file that contains information about the video data, such as the width, height, video type, frame size and/or the like. It is then followed by the frame data with some trailing space at the end of each frame. This trailing space is the storage for the extensions. The extension puts a structure into this space in order to store meta-data in a consistent format. All the data is stored as attributes (named values).

### File Header:

The file header layout is depicted as follows. It contains information about the image properties, such as width and height, which provides the spatial resolution. Image type is an enumerated constant. Currently supported image types are:
Bayer,
Grayscale and
RGB24.

Frame Size is the total size of the frame which contains the image, attribute table and all the attribute data. A VID file is essentially the header appended by one or more frames of frame size each.

| Byte Offset | Data Format | Field | Comments |
|---|---|---|---|
| 0-3 | unsigned long | Header Size | Size of the |
| | | | header |
| 4-5 | unsigned short | Image Type | Enumerated |
| | | | constant. |
| 6-7 | unsigned short | Image Width | |
| 8-9 | unsigned short | Image Height | |
| 10-13 | unsigned long | Frame Size | |

### Frame Data With Trailing Space:

Following the file header are one or more frames. Each frame consists of the image followed by the attribute table and data. The image size is derived from the image type, image width and image height. First, depending on the image type and image width, stride is calculated. Stride is essentially a 4 byte aligned byte array containing one scan line. It is calculated using the following formula:

stride=((((bits)+31)/32)*4)

And bits is calculated as:

bits=(image_width*bits_per_pixel)

As an example, for a 638×480 resolution 8 bit bayer image, stride is calculated as follows:

bits=(638*8)=5104

stride=((((5104)+31)/32)*4)=640

Taking another example, for a 1023*768 resolution 24 bit RGB image, stride is calculated as follows:

bits=(1023*24)=24552

stride=((((24552)+31)/32)*4)=3072

Now it is easy to calculate the image size:

image_size=stride*image_height

In the example above, a 638×480 8 bit bayer image will have:

image_size=640*480=307200 bytes

and the 1023×768 24 bit RGB image will have:

image_size=3072*768=2359296 bytes

As is clear from the above, the image size depends on the image type. Adding support for a new image format is easy. The VID file driver can be customized with the new image format (such as a 4 byte contains 3 pixels or the like) so that the internal calculations for the image size and frame size are kept consistent. This new format can be given a new enumerated constant ID and recorded in the file header as Image Type. The VID file can contain the image data, which can be retrieved transparently by the driver but the interpretation or processing of the image data is left to the application.

### Frame Attributes:

Following the image is the trailing space which contains the attribute table. The attribute table starts with a “MAGIC NUMBER” or signature to identify that the following data is indeed an attribute table with offset pointers in order to avoid misinterpreting the data. It is then followed by “Number of Attributes” field that represents the number of entries in the attribute table.

| Byte Offset | Data Format | Field | Comments |
|---|---|---|---|
| 0-3 | bytes | Magic Number | 0x62614C56 |
| 4-5 | unsigned short | Number of | |
| | | Attributes | |

It is then followed by number of attribute entries, each is a structure depicted as follows.

| Byte Offset | Data Format | Field | Comments |
|---|---|---|---|
| 0-15 | bytes | Attribute Name | |
| 16-19 | unsigned long | Attribute Size | |
| 20 | byte | Valid Flag | |
| 21-24 | unsigned long | Offset pointer | Pointer to data |

Actual data starts immediately following the attribute table. A frame contains all the data for image, attribute table and the attribute data. The attribute data is application dependant. VID file and the driver treat the attribute data as BLOBs (binary large objects) and avoid interpreting it, leaving the job for the application which is aware of the data, its format and the like.

Any data or information, such as the annotation data which is XML string, application specific data such as the output of the image processing algorithmic steps, different sensor data such as RADAR or TOF data that needs to be synchronized with the image data or multiple images from different image sensors such as SVS (surround view system) that needs to be synchronized for processing and stitching purposes and the like, can be conveniently stored in the same file facilitating the algorithm development and evaluation/testing.

### Image Compression:

As is clear from the above, the image data can be stored in any format that the application using it understands. From the algorithm development point of view, the following important criteria should be met.
Inter frame compression is not desirable. Any compression applied should be applied on the same frame. Previous or next frame cannot be referenced as it is done in various video formats such as MPEG2.
Lossy compression is not allowed. Any compression algorithm that loses data is not suitable for image processing algorithm development because the compression artifacts can skew the application.
Any application that is developed for the embedded implementation requires having a constant frame size. It is not very desirable to use a frame with varying size, which would invariably result from a lossless compression algorithm since the compression ratio would depend on the image content.

Any video file format that contains multiple frames and uses a lossless compression will invariably result in a variable frame size. To accommodate this requirement, an equivalent of a linked list of frames or a table containing offsets to each frame must be maintained. This will make the video processing extremely inefficient, as the time required to seek to a given frame randomly will depend on the relative position of that frame. Later frames will need higher access time as the linked list has to be traversed to access that frame. This will render a larger video file extremely inconvenient for processing. Besides, the compression ratio obtained by the lossless compression algorithm very rarely exceeds 3:1 and is extremely content dependant (training data would invariably require a lot of different scenarios making lossless compression which depends on repetition in pattern, ineffective). Coupled with relatively cheap storage available, applying compression on the training and testing video data doesn't yield the benefits that a superficial analysis would suggest.

With these requirements in mind, VID file format doesn't support compression natively. If one is desired, certainly it can be supported by creating a new image format with some padding data applied to the compressed images to make a consistent frame size.

### Video Control & Interface:

### Overview:

The VIDCtrl (Video Interface & Control) is Magna Vectrics' (MEVC) development platform that allows interfacing with different sensors (image sensor, TOF sensor and/or the like) through an open architecture and a consistent interface with a built-in facility for recording the data. It also serves as a gateway for Simulink, the algorithm development platform, to access live sensor data.

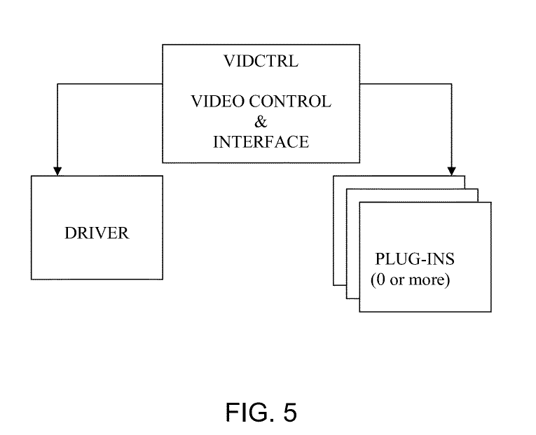

Essentially, and as shown in FIG. 5, the structure of VIDCtrl consists of a replaceable driver, which interfaces with the actual device and zero or more plug-ins.

The driver exports its services by implementing an API structure supported by VIDCtrl. It leverages the VID format extensions to embed the complete sensor data within a frame structure. This data is easily accessible to any VID Format Extensions aware application component. VIDCtrl can thus interface with any (one or more) physical devices, leaving the job of actual interface to the relevant driver and extracting all the sensor data in a uniform manner.

Zero or more plug-ins can be configured to be loaded by VIDCtrl. A plug-in is a dynamic link library (dll) implementing an API structure supported by VIDCtrl. VIDCtrl passes every frame acquired by the driver to the plug-ins for any further processing thus allowing for extending the platform in a substantially or completely flexible way (different algorithm components or applications can be implemented as plug-ins).

### Driver:

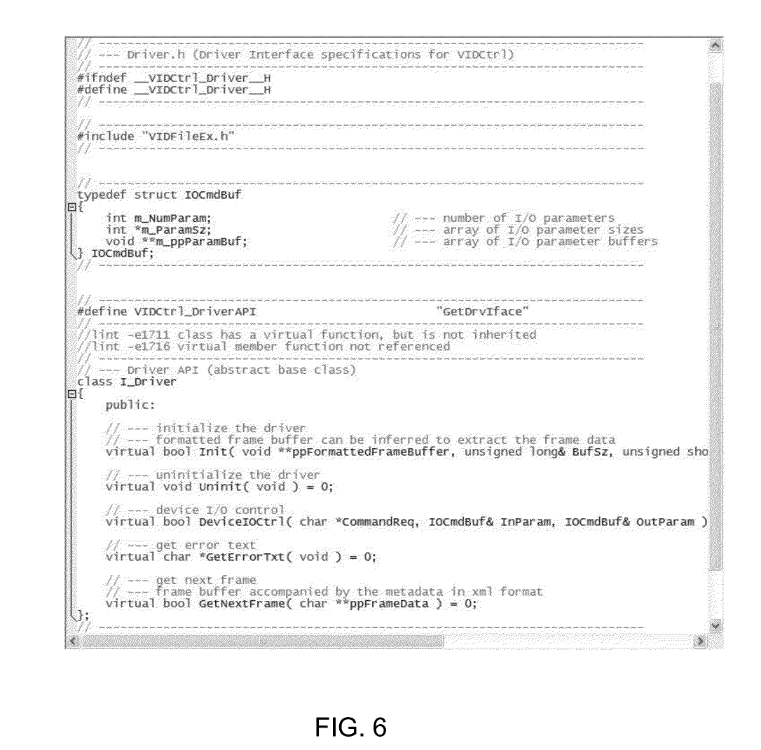

As shown in FIG. 6, VIDCtrl loads a driver that is configured through its configuration file ‘VIDCtrl.INI’. It queries the driver for an interface function ‘GetDrvIFace’ and expects to receive a pointer to the interface class. It then initializes the driver by calling its ‘Init’ function and receives a formatted buffer address along with the information that can be used to access all the frame data through VID Format Extension interface. At a pre-configured interval, it then calls the driver for ‘GetNextFrame’ to acquire the next frame from the sensor until the user shuts down VIDCtrl, at which time, it first calls ‘Uninit’ to allow the driver to terminate its connection to the physical devices that it is controlling and perform any necessary cleanups before unloading it. Any sensor specific IO Control is performed through ‘DeviceIOCtrl’.

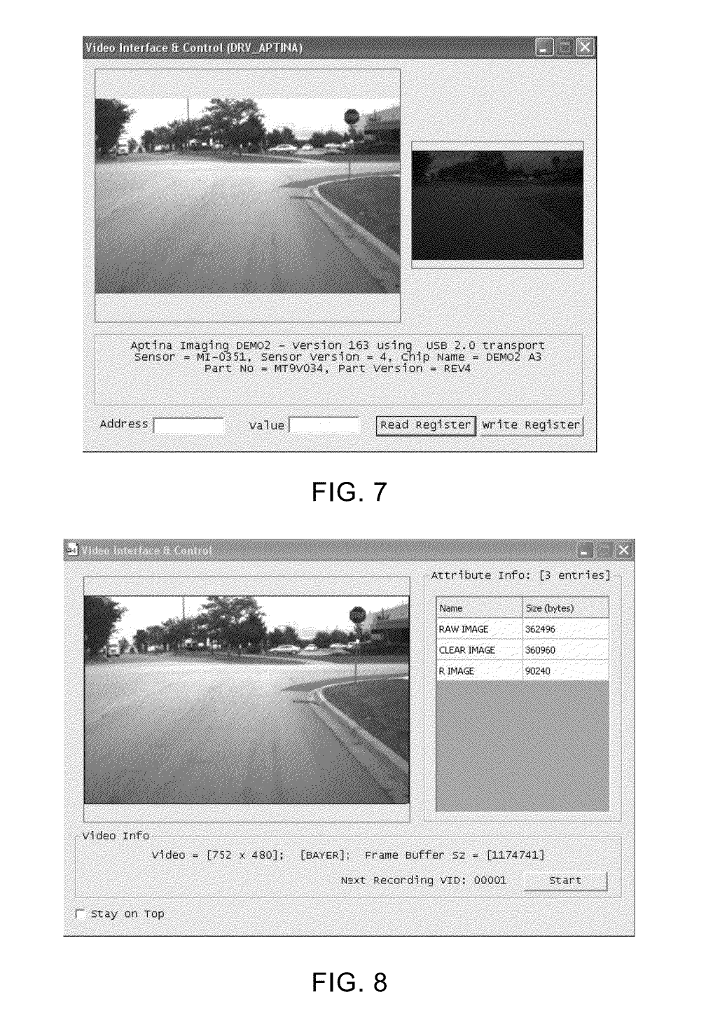

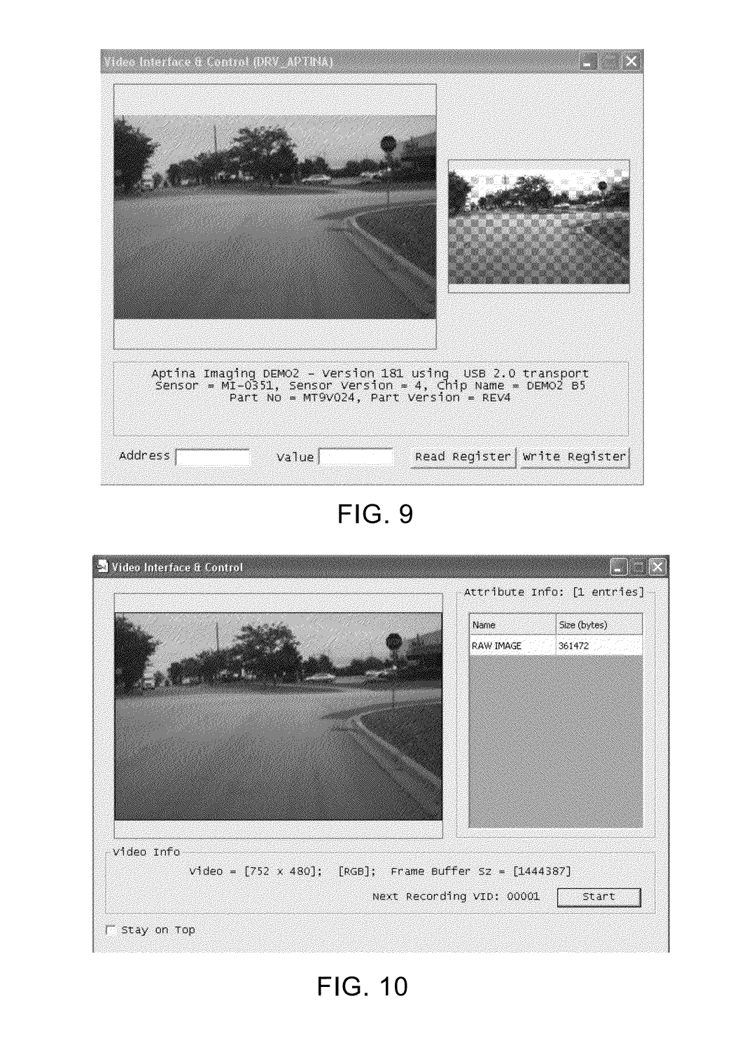

FIGS. 7-10 show an example of a driver interfacing with the Aptina sensor (RCCC and RGB) with the corresponding user interface for VIDCtrl displaying the information about the embedded frame data. Also note the ‘Start’ button which allows for the recording of all the sensor data to a VID format video file.

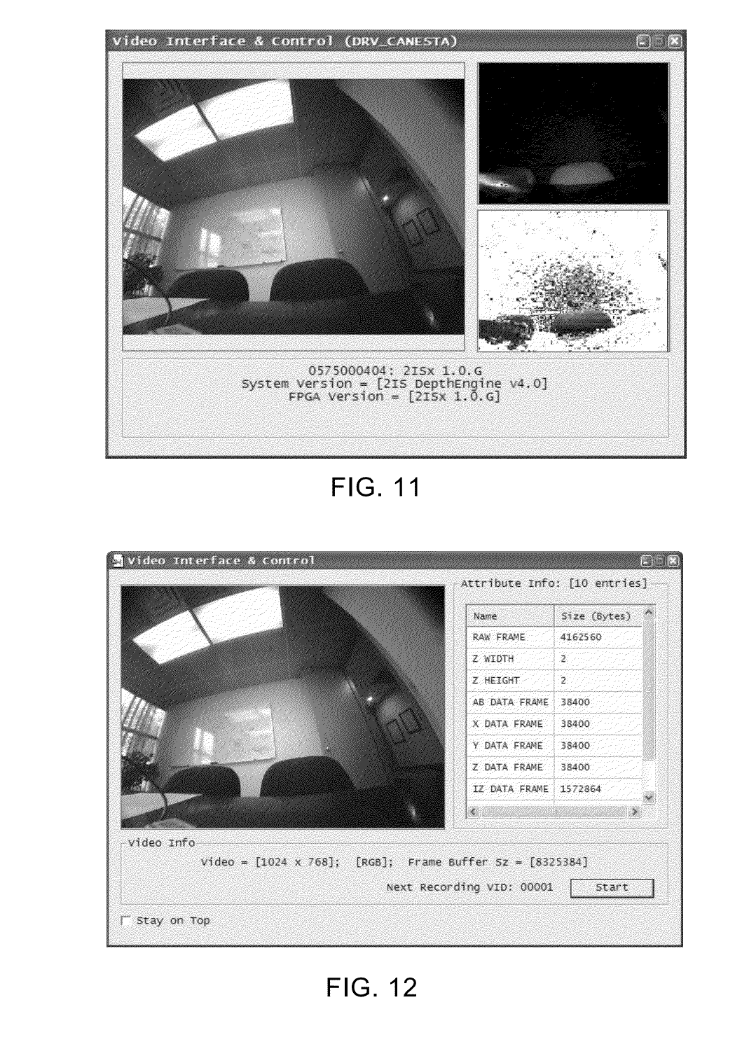

FIGS. 11 and 12 show another example of a driver interfacing with the Canesta M3 sensor. The same mechanism allows for the recording of the sensor data to the VID format video file.

### Plug-In

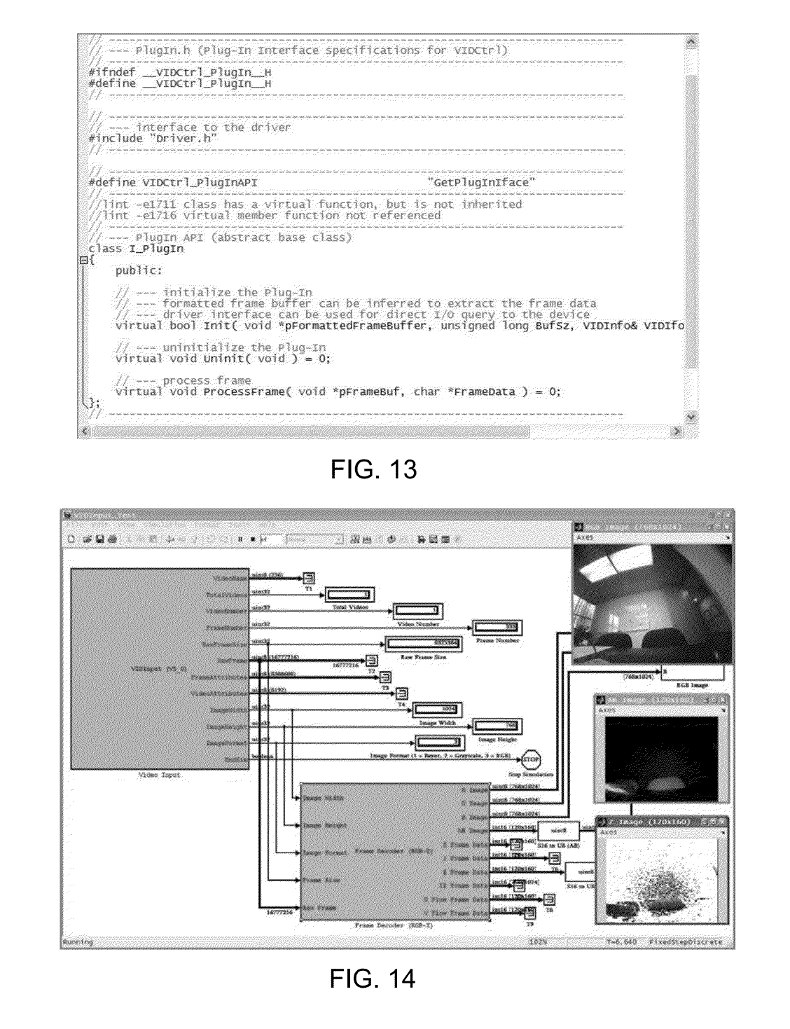

Plug-ins allow for extending VIDCtrl in a consistent way. As shown in FIG. 13,

VIDCtrl loads the plug-in that is configured through its configuration file ‘VIDCtrl.INI’. It queries the plug-in for an interface function ‘GetPlugInIFace’ and expects to receive a pointer to the interface class. It then initializes the plug-in by calling its ‘Init’ function and passes a formatted buffer along with the information that can be used to access all the frame data through VID Format Extension interface. At a pre-configured interval, it then calls the plug-in and passes the new frame captured by the loaded driver for any processing that the plug-in is implementing, until the user shuts down VIDCtrl at which time, it first calls ‘Uninit’ to allow the plug-in to perform any necessary cleanups before unloading it.

Any algorithm or application can be implemented as a plug-in. A plug-in can control the sensor device through the driver interface which it receives at the initialization time. Multiple applications can be loaded and run simultaneously with this simple but effective mechanism which allows for live interface with the sensor or to the recorded data in a completely transparent way.

### Simulink Interface:

VIDCtrl facilitates the algorithm development platform—Simulink to interface with the sensor (live or recorded data) in a consistent way (FIG. 14). It creates a memory mapped region containing a circular buffer for placing the captured frames. The depth of the circular buffer can be controlled through the configuration file. An S-Function implemented in Simulink, called ‘VIDInput’, interfaces with this memory mapped region through VID Format Extension interface to access the sensor data. Sensor specific ‘Frame Decoder’ S-Function extracts the sensor data from the frame buffer and extends it to the rest of the algorithmic components.

This mechanism allows for interfacing any sensor and transporting its data to the algorithm implemented in simulink making it a very powerful, flexible and effective development platform.

### Application Control:

### Overview:

Application Control (APPCtrl) is a software engine that allows for the processing of different applications (object detection, camera calibration and/or the like). APPCtrl uses an open architecture with a consistent interface. APPCtrl has a built-in facility for accessing live or offline video/sensor data. Algorithmic processing is accomplished with a number of run-time configurable plug-ins.

APPCtrl creates a framework and defines protocols in such a way that complicated algorithmic modules can be built in a modular way. One module (Plug-In) can process data from an upstream module and pass on its output for further processing by the downstream modules. A library of such modules can be developed and re-used for different algorithmic applications. APPCtrl serves both an algorithm development platform and application showcase for both internal testing and customer demonstration.

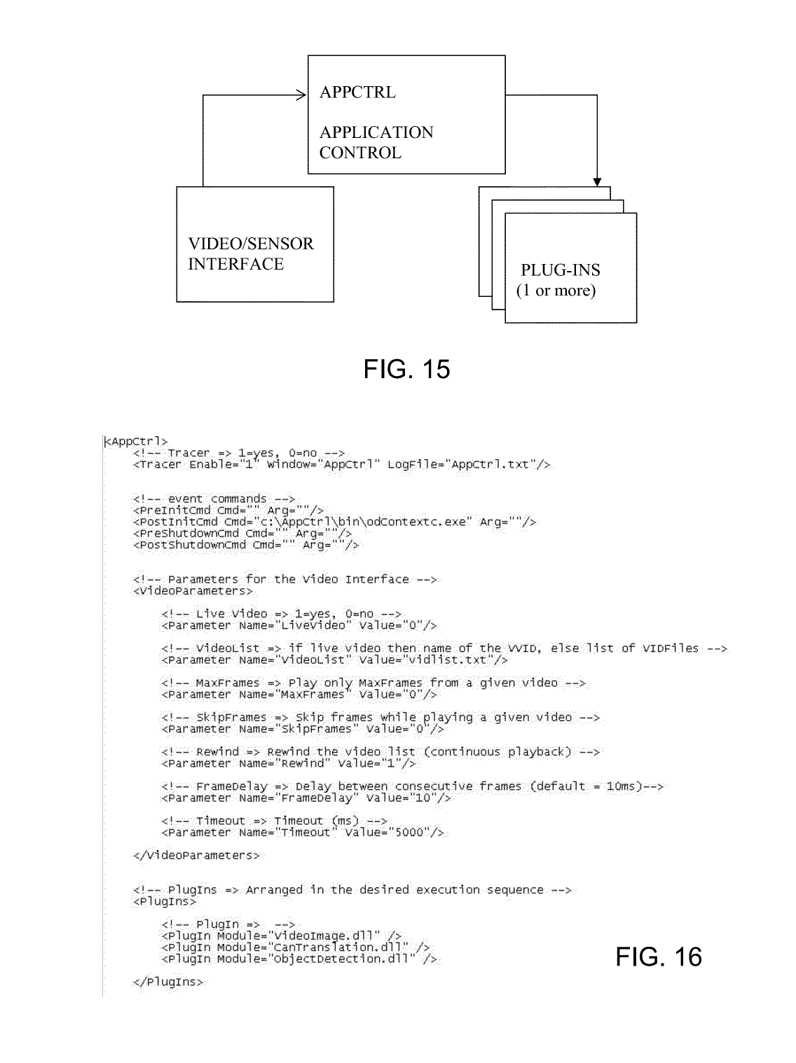

As shown in FIG. 15, the structure of APPCtrl consists of a video/sensor interface to gather the required video/sensor stream and a series of plug-ins that comprise the application and process the video/sensor data. One or more plug-ins can be configured to be loaded by APPCtrl. A plug-in is a dynamic link library (dll) implementing an API structure supported by APPCtrl. APPCtrl passes every frame acquired to the plug-ins for processing, thus allowing for the extension of the platform in a completely flexible way (different algorithm components or applications are implemented as plug-ins). An example of the APPCtrl configuration file is shown in FIG. 16.

### Video/Sensor Interface:

APPCtrl uses a video format (VIDFormat) for the loading of video/sensor data. APPCtrl can load video/sensor information via either a list of previous recorded file or through a virtual VID buffer allowing for live processing. The video/sensor type to be used is configured through APPCtrl's configuration file ‘APPCtrl.INI’.

### Plug-In:

Plug-ins are the where the APPCtrl performs its processing functions. APPCtrl loads the plug-in that is configured through its configuration file ‘APPCtrl.INI’. APPCtrl and the plug-ins utilize the same memory. Information is shared via a pointer to public data structures, thus no memory copies are required allowing for increased efficiency. Details on the data to be shared are described in header files via an interface class. Data can be also shared between the various plug-ins via this mechanism.

APPCtrl initializes the plug-in by calling its ‘Init’ function. At a pre-configured interval, it then calls the plug-in ‘Process’ function where the plug performs its algorithmic function. The plugin is free to use any data shared from either the APPCtrl or other plug-ins. The processing continues until the user shuts down APPCtrl, at which time it calls the ‘Uninit’ function allowing for the plug-in to perform any necessary cleanups and then unloading it.

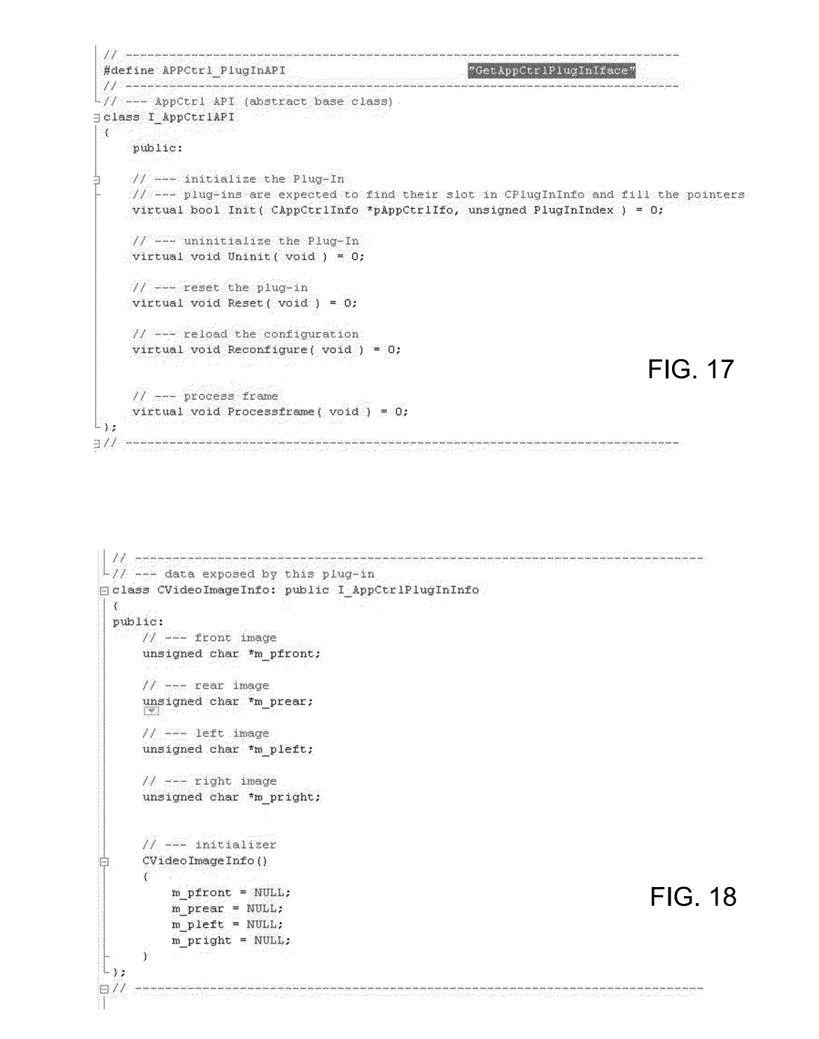

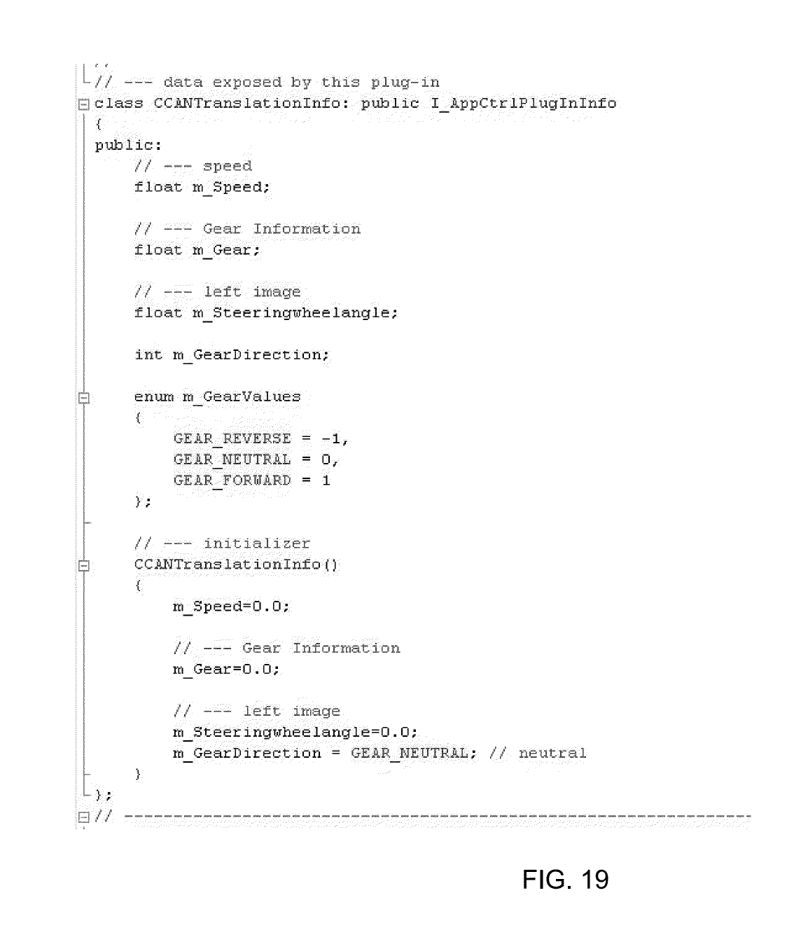

APPCtrl defines a protocol for the plug-ins and makes the basic data available systematically with very low overhead. Each module can publish its interface and shared data for use by subsequent modules enabling the development of a complicated algorithm quickly without dealing with issues such as device interface, data recording and the like. The APPCtrl API that is available to the plugins is shown in FIG. 17, while an example of the data exposed by a VideoImage PlugIn is shown in FIG. 18, and an example of the data exposed by a CANTranslation PlugIn is shown in FIG. 19.

Thus, the present invention provides a video file format that makes all the required data available in a synchronized way, enabling the easy access for the algorithm. The format creates a layout that allows it to store and later find the data in a very generalized way such that standard tools can be developed to handle even unknown data transparently. A driver software has been created such that all the data access has been abstracted to an API.

The VIDFormat software or system provides a mechanism to store video data along with other information, such as information received via CAN bus, multiple camera feeds and even annotation data, synchronized to a given frame is necessary for any image processing application such as DAS applications that we are working with. The file format stores video data along with other arbitrary information synchronized with frames. The present invention helped the algorithm development, since it provides the tools to go along with it and it allowed for building the data capture toolset and application development framework on this foundation.

The Video Control Interface (VIDCtrl) provides a software tool that defines a protocol for interfacing with external devices (such as cameras) and subsequent processing software. It loads a run-time configurable driver (which conforms to the protocol) to interface a given device in question and makes the data available in the VID format to run-time configurable plug-ins that can post process the captured data before storing it on a disk file with VID Format. Thus, any device can be interfaced, its data captured and stored for algorithmic processing. This can be done live or off-line transparently to the algorithmic processing software. Basically, it is an engine that loads a configurable driver and zero or more software plug-ins that conform to the defined API. It pumps the data captured by the driver using the VID format through all the plug-ins. With this framework, a data recording mechanism can be easily created. This forms the basis of any DAS application development and testing. A mechanism to interface with the sensor devices (such as cameras for surround view systems, cameras and TOF sensors for sensor fusion applications) systematically and to access that data for algorithmic processing is useful for DAS applications, and the VIDCtrl system or software can readily perform these functions. The VIDCtrl provides a sensor interface that is systematically isolated from the algorithmic processing and the sensor data is made available either on-line or off-line transparently. It is this innovation coupled with the VID format has been the foundation of algorithmic development starting with VOCS (vision based occupant classification system) and then later migrating to DAS applications such as LDW (lane departure warning), FCW (forward collision warning) and recently SVS system for both OC (online calibration) and OD (object detection).

The Application Control (AppCtrl) provides a software engine that loads a run-time configurable algorithmic plug-ins. It can interface with VIDCtrl for live processing or to VID files for off-line processing. It creates a framework and defines protocols such that complicated algorithmic modules can be built in a modular way. One module can process data from an upstream module and pass on its output for further processing by the downstream modules. A library of such modules can be developed and re-used for different algorithmic applications. The AppCtrl defines protocol for the plug-ins and makes the basic data available systematically with very low overhead. Each module can publish its interface and data for use by subsequent module enabling the development of a complicated algorithm quickly without dealing with issues such as device interface, data recording and the like. A low overhead framework was necessary to get algorithmic development up and running quickly. The algorithmic modules are stackable such that they can use each other's processing capability and data with minimal overhead (no memory copies). The software enables the algorithm development by providing a framework to deliver necessary data either in live mode or off-line mode and allows for the algorithm modules to be stacked. The AppCtrl allows for the provision of fast track development of OD and demonstration to the OEM.

Thus, the software and systems of the present invention are suitable for use in imaging or vision systems of vehicles, such as machine vision systems or display systems. The software and systems of the present invention utilize image data captured by one or more cameras of the vehicle and/or data or information captured by one or more other sensors of the vehicle, such as radar sensors, lidar sensors, time of flight sensors and/or the like. The imaging sensors or cameras may be disposed at the vehicle and may have exterior fields of view, such as forward and/or rearward and/or sideward with respect to the vehicle.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in PCT Application No. PCT/US2012/066570, filed Nov. 27, 2012 (Attorney Docket MAG04 FP-1960(PCT)), and/or PCT Application No. PCT/US2012/066571, filed Nov. 27, 2012 (Attorney Docket MAG04 FP-1961(PCT)), which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580; and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, an array of a plurality of photosensor elements arranged in at least 640 columns and 480 rows (preferably a megapixel imaging array or the like), with a respective lens focusing images onto respective portions of the array. The photosensor array may comprise a plurality of photosensor elements arranged in a photosensor array having rows and columns. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or International Publication Nos. WO 2011/028686; WO 2010/099416; WO 2012/061567; WO 2012/068331; WO 2012/075250; WO 2012/103193; WO 2012/0116043; WO 2012/0145313; WO 2012/0145501; WO 2012/145818; WO 2012/145822; WO 2012/158167; WO 2012/075250; WO 2012/103193; WO 2012/0116043; WO 2012/0145501; WO 2012/0145343; WO 2012/154919; WO 2013/019707; WO 2013/016409; WO 2012/145822; WO 2013/067083; WO 2013/070539; WO 2013/043661; WO 2013/048994; WO 2013/063014, WO 2013/081984; WO 2013/081985; WO 2013/074604; WO 2013/086249 and/or PCT Application No. PCT/US2012/056014, filed Sep. 19, 2012 (Attorney Docket MAG04 FP-1937 (PCT)), and/or PCT/US2012/071219, filed Dec. 21, 2012 (Attorney Docket MAG04 FP-1982 (PCT)); and/or PCT Application No. PCT/US2012/071219, filed Dec. 21, 2012 (Attorney Docket MAG04 FP-1982 (PCT)), and/or PCT Application No. PCT/US2013/022119, filed Jan. 18, 2013 (Attorney Docket MAG04 FP-1997(PCT)), and/or PCT Application No. PCT/US2013/026101, filed Feb. 14, 2013 (Attorney Docket MAG04 FP-2010 (PCT)), and/or PCT Application No. PCT/US2013/027342, filed Feb. 22, 2013 (Attorney Docket MAG04 FP-2014(PCT)), and/or PCT Application No. PCT/US2013/036701, filed Apr. 16, 2013 (Attorney Docket MAG04 FP-2047 (PCT)) and/or U.S. patent application Ser. No. 13/927,680, filed Jun. 26, 2013 (Attorney Docket MAG04 P-2091); Ser. No. 13/916,051, filed Jun. 12, 2013 (Attorney Docket MAG04 P-2081); Ser. No. 13/894,870, filed May 15, 2013 (Attorney Docket MAG04 P-2062); Ser. No. 13/887,724, filed May 6, 2013 (Attorney Docket No. MAG04 P-2072); Ser. No. 13/851,378, filed Mar. 27, 2013 (Attorney Docket MAG04 P-2036); Ser. No. 61/848,796, filed Mar. 22, 2012 (Attorney Docket MAG04 P-2034); Ser. No. 13/847,815, filed Mar. 20, 2013 (Attorney Docket MAG04 P-2030); Ser. No. 13/800,697, filed Mar. 13, 2013 (Attorney Docket MAG04 P-2030); Ser. No. 13/785,099, filed Mar. 5, 2013 (Attorney Docket MAG04 P-2017); Ser. No. 13/779,881, filed Feb. 28, 2013 (Attorney Docket MAG04 P-2028); Ser. No. 13/774,317, filed Feb. 22, 2013 (Attorney Docket MAG04 P-2015); Ser. No. 13/774,315, filed Feb. 22, 2013 (Attorney Docket MAG04 P-2013); Ser. No. 13/681,963, filed Nov. 20, 2012 (Attorney Docket MAG04 P-1983); Ser. No. 13/660,306, filed Oct. 25, 2012 (Attorney Docket MAG04 P-1950); Ser. No. 13/653,577, filed Oct. 17, 2012 (Attorney Docket MAG04 P-1948); and/or Ser. No. 13/534,657, filed Jun. 27, 2012 (Attorney Docket MAG04 P-1892), and/or U.S. provisional application Ser. No. 61/838,619, filed Jun. 24, 2013; Ser. No. 61/838,621, filed Jun. 24, 2013; Ser. No. 61/837,955, filed Jun. 21, 2013; Ser. No. 61/837,369, filed Jun. 20, 2013; Ser. No. 61/836,900, filed Jun. 19, 2013; Ser. No. 61/836,380, filed Jun. 18, 2013; Ser. No. 61/834,129, filed Jun. 12, 2013; Ser. No. 61/834,128, filed Jun. 12, 2013; Ser. No. 61/833,080, filed Jun. 10, 2013; Ser. No. 61/830,375, filed Jun. 3, 2013; Ser. No. 61/830,377, filed Jun. 3, 2013; Ser. No. 61/825,752, filed May 21, 2013; Ser. No. 61/825,753, filed May 21, 2013; Ser. No. 61/823,648, filed May 15, 2013; Ser. No. 61/823,644, filed May 15, 2013; Ser. No. 61/821,922, filed May 10, 2013; Ser. No. 61/819,835, filed May 6, 2013; Ser. No. 61/819,033, filed May 3, 2013; Ser. No. 61/16,956, filed Apr. 29, 2013; Ser. No. 61/815,044, filed Apr. 23, 2013; Ser. No. 61/814,533, filed Apr. 22, 2013; Ser. No. 61/813,361, filed Apr. 18, 2013; Ser. No. 61/840,407, filed Apr. 10, 2013; Ser. No. 61/808,930, filed Apr. 5, 2013; Ser. No. 61/807,050, filed Apr. 1, 2013; Ser. No. 61/806,674, filed Mar. 29, 2013; Ser. No. 61/806,673, filed Mar. 29, 2013; Ser. No. 61/804,786, filed Mar. 25, 2013; Ser. No. 61/793,592, filed Mar. 15, 2013; Ser. No. 61/793,614, filed Mar. 15, 2013; Ser. No. 61/793,558, filed Mar. 15, 2013; Ser. No. 61/772,015, filed Mar. 4, 2013; Ser. No. 61/772,014, filed Mar. 4, 2013; Ser. No. 61/770,051, filed Feb. 27, 2013; Ser. No. 61/770,048, filed Feb. 27, 2013; Ser. No. 61/766,883, filed Feb. 20, 2013; Ser. No. 61/760,366, filed Feb. 4, 2013; Ser. No. 61/760,364, filed Feb. 4, 2013; Ser. No. 61/758,537, filed Jan. 30, 2013; Ser. No. 61/756,832, filed Jan. 25, 2013; Ser. No. 61/754,804, filed Jan. 21, 2013; Ser. No. 61/745,925, filed Dec. 26, 2012; Ser. No. 61/745,864, filed Dec. 26, 2012; Ser. No. 61/736,104, filed Dec. 12, 2012; Ser. No. 61/736,103, filed Dec. 12, 2012; Ser. No. 61/735,314, filed Dec. 10, 2012; Ser. No. 61/734,457, filed Dec. 7, 2012; Ser. No. 61/733,598, filed Dec. 5, 2012; Ser. No. 61/733,093, filed Dec. 4, 2012; Ser. No. 61/727,912, filed Nov. 19, 2012; Ser. No. 61/727,911, filed Nov. 19, 2012; Ser. No. 61/727,910, filed Nov. 19, 2012; Ser. No. 61/718,382, filed Oct. 25, 2012; Ser. No. 61/713,772, filed Oct. 15, 2012; Ser. No. 61/710,924, filed Oct. 8, 2012; Ser. No. 61/710,247, filed Oct. 2, 2012; Ser. No. 61/696,416, filed Sep. 4, 2012; Ser. No. 61/682,995, filed Aug. 14, 2012; Ser. No. 61/682,486, filed Aug. 13, 2012; Ser. No. 61/680,883, filed Aug. 8, 2012; and/or Ser. No. 61/678,375, filed Aug. 1, 2012, which are all hereby incorporated herein by reference in their entireties. The system may communicate with other communication systems via any suitable means, such as by utilizing aspects of the systems described in International Publication No. WO 2013/043661, PCT Application No. PCT/US10/038477, filed Jun. 14, 2010, and/or PCT Application No. PCT/US2012/066571, filed Nov. 27, 2012 (Attorney Docket MAG04 FP-1961(PCT)), and/or U.S. patent application Ser. No. 13/202,005, filed Aug. 17, 2011 (Attorney Docket MAG04 P-1595), which are hereby incorporated herein by reference in their entireties.

The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454; and 6,824,281, and/or International Publication Nos. WO 2010/099416 and/or WO 2011/028686, and/or U.S. patent application Ser. No. 12/508,840, filed Jul. 24, 2009, and published Jan. 28, 2010 as U.S. Pat. Publication No. US 2010-0020170, and/or PCT Application No. PCT/US2012/048110, filed Jul. 25, 2012 (Attorney Docket MAG04 FP-1907(PCT)), and/or U.S. patent application Ser. No. 13/534,657, filed Jun. 27, 2012 (Attorney Docket MAG04 P-1892), which are all hereby incorporated herein by reference in their entireties. The camera or cameras may comprise any suitable cameras or imaging sensors or camera modules, and may utilize aspects of the cameras or sensors described in U.S. patent application Ser. No. 12/091,359, filed Apr. 24, 2008 and published Oct. 1, 2009 as U.S. Publication No. US-2009-0244361; and/or Ser. No. 13/260,400, filed Sep. 26, 2011 (Attorney Docket MAG04 P-1757), and/or U.S. Pat. Nos. 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,004,606; 7,720,580; and/or 7,965,336, and/or International Publication Nos. WO/2009/036176 and/or WO/2009/046268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149; and/or 7,526,103, which are all hereby incorporated herein by reference in their entireties, a rain sensor, such as the types disclosed in commonly assigned U.S. Pat. Nos. 6,353,392; 6,313,454; 6,320,176; and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,720,580; 7,038,577; 5,929,786 and/or 5,786,772, and/or U.S. patent application Ser. No. 11/239,980, filed Sep. 30, 2005, now U.S. Pat. No. 7,881,496, and/or U.S. provisional application Ser. No. 60/628,709, filed Nov. 17, 2004; Ser. No. 60/614,644, filed Sep. 30, 2004; Ser. No. 60/618,686, filed Oct. 14, 2004; Ser. No. 60/638,687, filed Dec. 23, 2004, which are hereby incorporated herein by reference in their entireties, a video device for internal cabin surveillance and/or video telephone function, such as disclosed in U.S. Pat. Nos. 5,760,962; 5,877,897; 6,690,268; and/or 7,370,983, and/or U.S. patent application Ser. No. 10/538,724, filed Jun. 13, 2005 and published Mar. 9, 2006 as U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. No. 7,255,451 and/or U.S. Pat. No. 7,480,149; and/or U.S. patent application Ser. No. 11/226,628, filed Sep. 14, 2005 and published Mar. 23, 2006 as U.S. Publication No. US-2006-0061008, and/or Ser. No. 12/578,732, filed Oct. 14, 2009 (Attorney Docket DON01 P-1564), which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. No. 6,690,268 and/or U.S. patent application Ser. No. 13/333,337, filed Dec. 21, 2011 (Attorney Docket DON01 P-1797), which are hereby incorporated herein by reference in their entireties. The video mirror display may comprise any suitable devices and systems and optionally may utilize aspects of the compass display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252; and/or 6,642,851, and/or European patent application, published Oct. 11, 2000 under Publication No. EP 0 1043566, and/or U.S. patent application Ser. No. 11/226,628, filed Sep. 14, 2005 and published Mar. 23, 2006 as U.S. Publication No. US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in International Publication No. WO 2012/051500, which is hereby incorporated herein by reference in its entirety).

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described International Publication Nos. WO 2010/099416; WO 2011/028686; WO 2012/075250; WO 2013/019795; WO 2012-075250; WO 2012/154919; WO 2012/0116043; WO 2012/0145501; and/or WO 2012/0145313, and/or PCT Application No. PCT/CA2012/000378, filed Apr. 25, 2012 (Attorney Docket MAG04 FP-1819(PCT)), and/or PCT Application No. PCT/US2012/066571, filed Nov. 27, 2012 (Attorney Docket MAG04 FP-1961(PCT)), and/or PCT Application No. PCT/US2012/068331, filed Dec. 7, 2012 (Attorney Docket MAG04 FP-1967(PCT)), and/or PCT Application No. PCT/US2013/022119, filed Jan. 18, 2013 (Attorney Docket MAG04 FP-1997(PCT)), and/or U.S. patent application Ser. No. 13/333,337, filed Dec. 21, 2011 (Attorney Docket DON01 P-1797), which are hereby incorporated herein by reference in their entireties.

Optionally, a video mirror display may be disposed rearward of and behind the reflective element assembly and may comprise a display such as the types disclosed in U.S. Pat. Nos. 5,530,240; 6,329,925; 7,855,755; 7,626,749; 7,581,859; 7,446,650; 7,370,983; 7,338,177; 7,274,501; 7,255,451; 7,195,381; 7,184,190; 5,668,663; 5,724,187 and/or 6,690,268, and/or in U.S. patent application Ser. No. 12/091,525, filed Apr. 25, 2008, now U.S. Pat. No. 7,855,755; Ser. No. 11/226,628, filed Sep. 14, 2005 and published Mar. 23, 2006 as U.S. Publication No. US-2006-0061008; and/or Ser. No. 10/538,724, filed Jun. 13, 2005 and published Mar. 9, 2006 as U.S. Publication No. US-2006-0050018, which are all hereby incorporated herein by reference in their entireties. The display is viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates of the reflective element may be selected to provide a desired color or tint to the mirror reflective element, such as a blue colored reflector, such as is known in the art and such as described in U.S. Pat. Nos. 5,910,854; 6,420,036; and/or 7,274,501, which are hereby incorporated herein by reference in their entireties.

Optionally, the display or displays and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742; and 6,124,886, and/or U.S. patent application Ser. No. 10/538,724, filed Jun. 13, 2005 and published Mar. 9, 2006 as U.S. Publication No. US-2006-0050018, which are hereby incorporated herein by reference in their entireties.

Changes and modifications to the specifically described embodiments may be carried out without departing from the principles of the present invention, which is intended to be limited only by the scope of the appended claims as interpreted according to the principles of patent law.

1. A vision system for a vehicle, said vision system comprising:
a plurality of cameras disposed at a vehicle equipped with said vision system, each of said cameras having a respective field of view and being operable to capture respective image data; and
wherein said vision system utilizes a video file format that makes available desired image data and other information in a synchronized way, enabling access to the image data and information by algorithms, and wherein said video file format creates a layout that allows said vision system to store and access the data in a generalized manner.

2. The vision system of claim 1, comprising a video control interface software tool that defines a protocol for interfacing with external devices and subsequent processing software.

3. The vision system of claim 2, wherein said video control interface software tool is operable to load a run-time configurable driver that conforms to the protocol to interface a given device and to make the data available in a video file format to run-time configurable plug-ins that can post process the captured data before storing it on a disk file with video file format.

4. The vision system of claim 1, comprising an application control software engine that is operable to load run-time configurable algorithmic plug-ins.

5. The vision system of claim 4, wherein said application control software engine can interface with the video control for live processing or to video files for off-line processing.

6. The vision system of claim 5, wherein said application control software engine creates a framework and defines protocols such that complicated algorithmic modules can be built in a modular way, and wherein one of said modules is operable to process data from an upstream one of said modules and pass on its output for further processing by one or more downstream modules.

7. A vision system for a vehicle, said vision system comprising:
a plurality of cameras disposed at a vehicle equipped with said vision system, each of said cameras having a respective field of view and being operable to capture respective image data; and
a video control interface software tool that defines a protocol for interfacing with external devices and subsequent processing software.

8. The vision system of claim 7, wherein said video control interface software tool is operable to load a run-time configurable driver that conforms to the protocol to interface a given device and to make the data available in a video file format to run-time configurable plug-ins that can post process the captured data before storing it on a disk file with video file format.

9. The vision system of claim 7, comprising an application control software engine that is operable to load run-time configurable algorithmic plug-ins.

10. The vision system of claim 9, wherein said application control software engine can interface with the video control for live processing or to video files for off-line processing.

11. The vision system of claim 10, wherein said application control software engine creates a framework and defines protocols such that complicated algorithmic modules can be built in a modular way, and wherein one of said modules is operable to process data from an upstream one of said modules and pass on its output for further processing by one or more downstream modules.

12. A vision system for a vehicle, said vision system comprising:
a plurality of cameras disposed at a vehicle equipped with said vision system, each of said cameras having a respective field of view and being operable to capture respective image data;
an application control software engine that is operable to load run-time configurable algorithmic plug-ins;
wherein said application control software engine can interface with a video control for live processing or to video files for off-line processing; and
wherein said application control software engine creates a framework and defines protocols such that complicated algorithmic modules can be built in a modular way, and wherein one of said modules is operable to process data from an upstream one of said modules and pass on its output for further processing by one or more downstream modules.

13. The vision system of claim 12, wherein said vision system utilizes a video file format that makes available desired image data and other information in a synchronized way, enabling access to the image data and information by algorithms, and wherein said video file format creates a layout that allows said vision system to store and access the data in a generalized manner.

14. The vision system of claim 13, comprising a video control interface software tool that defines a protocol for interfacing with external devices and subsequent processing software.

15. The vision system of claim 14, wherein said video control interface software tool is operable to load a run-time configurable driver that conforms to the protocol to interface a given device and to make the data available in a video file format to run-time configurable plug-ins that can post process the captured data before storing it on a disk file with video file format.

16. The vision system of claim 15, comprising a video control interface software tool that defines a protocol for interfacing with external devices and subsequent processing software.

17. The vision system of claim 16, wherein said video control interface software tool is operable to load a run-time configurable driver that conforms to the protocol to interface a given device and to make the data available in a video file format to run-time configurable plug-ins that can post process the captured data before storing it on a disk file with video file format.

18. The vision system of claim 17, wherein image data can be stored in an appropriate format for the particular application using the image data.

19. The vision system of claim 12, comprising a video control interface software tool that defines a protocol for interfacing with external devices and subsequent processing software.

20. The vision system of claim 19, wherein said video control interface software tool is operable to load a run-time configurable driver that conforms to the protocol to interface a given device and to make the data available in a video file format to run-time configurable plug-ins that can post process the captured data before storing it on a disk file with video file format.
